(19) United States
(12) Patent Application Publication
(10) Pub. No.: US 2016/0232474 A1
(43) Pub. Date: Aug. 11, 2016

(54) METHODS AND SYSTEMS FOR RECOMMENDING CROWDSOURCING TASKS

(71) Applicant: XEROX CORPORATION, Norwalk, CT (US)

(72) Inventors: GUANGYU ZOU, Liaoning (CN); ALVARO E. GIL, Rochester, NY (US)

(21) Appl. No.: 14/614,480

(22) Filed: Feb. 5, 2015

(51) Int. Cl. G06Q 10/06; G06Q 50/00

(52) U.S. Cl. CPC G06Q 10/063112; G06Q 50/01

(57) ABSTRACT

The disclosed embodiments illustrate methods and systems for recommending crowdsourcing tasks. A first crowdsourcing task is received from a requestor. Based on the first crowdsourcing tasks a set of second crowdsourcing tasks, previously attempted by one or more crowdworkers is determined. The set of second crowdsourcing tasks is determined based on a degree of similarity between the first crowdsourcing task and each of the one or more sets of second crowdsourcing tasks. Further, the first crowdsourcing task is recommended to a set of crowdworkers from the one or more crowdworkers based on performance of the set of crowdworkers on the set of second crowdsourcing tasks.

### TECHNICAL FIELD

The presently disclosed embodiments are related, in general, to crowdsourcing. More particularly, the presently disclosed embodiments are related to methods and systems for recommending crowdsourcing tasks to one or more workers.

### BACKGROUND

Crowdsourcing is a process of obtaining needed services, ideas, or content by soliciting contributions from a large group of people, and especially from an online community, rather than from traditional employees or suppliers. This large group of people is commonly referred to as crowdworkers. Crowdsourcing may enable scaling of business processes by outsourcing to a wide and diverse crowd.

Usually, in a crowdsourcing environment, a requestor may post a task on a crowdsourcing platform. The task is performed by one or more crowdworkers registered with the crowdsourcing platform. Typically, different tasks may require crowdworkers with different expertise to achieve desired efficiency in the tasks. In such a scenario, it becomes very difficult to ensure that the posted task is performed by crowdworkers with the desired expertise.

### SUMMARY

According to embodiments illustrated herein, there is provided a method for recommending crowdsourcing tasks. The method includes receiving, by one or more processors, a first crowdsourcing task from a requestor. The method further includes determining, by the one or more processors, a set of second crowdsourcing tasks, from one or more sets of second crowdsourcing tasks previously attempted by one or more crowdworkers. The set of second crowdsourcing tasks are determined based on a degree of similarity between the first crowdsourcing task and each of the one or more sets of second crowdsourcing tasks. The degree of similarity is determined based on a comparison between one or more first attributes associated with the first crowdsourcing task and one or more second attributes associated with each of the one or more sets of second crowdsourcing tasks. The method further includes recommending, by the one or more processors, the first crowdsourcing task to a set of crowdworkers from the one or more crowdworkers based on performance of the set of crowdworkers on the set of second crowdsourcing tasks.

According to embodiments illustrated herein, there is provided a system for recommending crowdsourcing tasks. The system for recommending crowdsourcing tasks comprises one or more processors. The one or more processors are configured to receive a first crowdsourcing task from a requestor. The one or more processors are further configured to determine a set of second crowdsourcing tasks, from one or more sets of second crowdsourcing tasks previously attempted by one or more crowdworkers. The set of second crowdsourcing tasks are determined based on a degree of similarity between the first crowdsourcing task and each of the one or more sets of second crowdsourcing tasks. The degree of similarity is determined based on a comparison between one or more first attributes associated with the first crowdsourcing task and one or more second attributes associated with each of the one or more sets of second crowdsourcing tasks. The one or more processors are further configured to recommend the first crowdsourcing task to a set of crowdworkers from the one or more crowdworkers based on performance of the set of crowdworkers on the set of second crowdsourcing tasks.

According to embodiments illustrated herein, there is provided a computer program product for use with a computer, the computer program product including a non-transitory computer readable medium. The non-transitory computer readable medium stores a computer program code for recommending crowdsourcing tasks. The computer program code is executable by one or more processors to receive a first crowdsourcing task from a requestor. The computer program code is executable by the one or more processors to determine a set of second crowdsourcing tasks, from one or more sets of second crowdsourcing tasks previously attempted by one or more crowdworkers. The set of second crowdsourcing tasks are determined based on a degree of similarity between the first crowdsourcing task and each of the one or more sets of second crowdsourcing tasks. The degree of similarity is determined based on a comparison between one or more first attributes associated with the first crowdsourcing task and one or more second attributes associated with each of the one or more sets of second crowdsourcing tasks. The computer program code is further executable by the one or more processors to recommend the first crowdsourcing task to a set of crowdworkers from the one or more crowdworkers based on performance of the set of crowdworkers on the set of second crowdsourcing tasks.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram that illustrates a computing device for recommending one or more crowdsourcing tasks to a crowdworker, in accordance with at least one embodiment;

FIG. 3 is a flowchart illustrating a method for creating a relationship graph from historical data of one or more second crowdsourcing tasks, in accordance with at least one embodiment;

FIG. 4 depicts a graphical representation of the relationship graph;

FIG. 5 is a flowchart illustrating a method for recommending one or more crowdsourcing tasks, in accordance with at least one embodiment; and

FIG. 6 illustrates an exemplary embodiment of a user interface presented on a requestor-computing device, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

“Crowdsourcing” refers to distributing tasks (hereinafter, also referred to as crowdsourcing tasks) by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

“Crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms may include, but are not limited to, Amazon Mechanical Turk, Crowd Flower, or Mobile Works.

“Crowdsourcing task” refers to a piece of work, an activity, an action, a job, an instruction, or an assignment to be performed. Crowdsourcing tasks may necessitate the involvement of one or more crowdworkers. Examples of the tasks may include, but are not limited to, image/video/text labeling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image analysis, directory compilation, or information search/retrieval.

“Crowdworker” refers to a workforce/worker(s) who may perform one or more tasks that generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be used interchangeably.

“Crowdworker profile” refers to a profile information pertaining to a crowdworker. For example, the profile of the crowdworker may include information, such as, but is not limited to, a location of the crowdworker, a gender of the crowdworker, an age of the crowdworker, hobbies of the crowdworker, a marital status of the crowdworker, an expertise associated with the crowdworker, an educational qualification of the crowdworkers, an occupation of the crowdworker, an income level of the crowdworker, an email address of the crowdworker, a contact number of the crowdworker, a number of successful tasks and a number of unsuccessful tasks attempted and/or completed by the one or more crowdworkers, and so forth.

“A first crowdsourcing task” refers to a new task posted by a requestor on the crowdsourcing platform.

“One or more second crowdsourcing tasks” refer to one or more tasks that have already been processed by one or more crowdworkers (i.e., historical tasks).

“One or more first attributes” refer to one or more attributes associated with the first crowdsourcing task. For example, the one or more first attributes may comprise, but are not limited to, a posting time of the crowdsourcing task, an expiry time of the crowdsourcing task, a task type associated with the crowdsourcing task, a unit price associated with the crowdsourcing task, and a task expertise associated with the crowdsourcing task.

“One or more second attributes” refer to one or more attributes associated with the one or more second crowdsourcing tasks. For example, the one or more second attributes may comprise, but are not limited to, information about one or more crowdworkers who had previously attempted the one or more second crowdsourcing tasks, one or more performance metrics associated with the one or more second crowdsourcing tasks, a posting time of the one or more second crowdsourcing tasks, an expiry time of the one or more second crowdsourcing tasks, a task type associated with the one or more second crowdsourcing tasks, a unit price associated with the one or more second crowdsourcing tasks, a task expertise associated with the one or more second crowdsourcing tasks, and a number of attempts associated with the one or more second crowdsourcing tasks.

“Performance Metrics” corresponds to a performance of the one or more crowdworkers on the one or more second crowdsourcing tasks. In an embodiment, the performance metrics include, but are not limited to, a completion time of the second crowdsourcing task, results/responses of the second crowdsourcing tasks, an accuracy associated with the second crowdsourcing task, and a responding time associated with the second crowdsourcing task.

“Posting time” refers to a time at which a requestor has posted a crowdsourcing task.

“Completion time of a task” refers to a time consumed by a crowdworker to complete a task.

“Expiry time” refers to a time at which a crowdsourcing task uploaded on the crowdsourcing platform will expire, i.e. will no longer be accessible to the crowdworkers.

“Responding time of a task” refers to a time consumed by a crowdworker to accept a task.

“Approval rate” refers to a ratio of approved tasks to rejected tasks.

“Accuracy” refers to a ratio of a number of correct responses to a total number of responses provided by a crowdworker for one or more tasks attempted by the crowdworker. A person skilled in the art would appreciate that the term “task accuracy” may refer to an average of task accuracy scores attained by a crowdworker on multiple tasks, if the crowdworker attempts multiple tasks.

“Task Type” refers to a categorization of tasks such that tasks of each task type may require a performance of similar type of steps. Examples of task type may include, but are not limited to, image/video/text labelling/tagging/categorisation, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image-analysis, directory compilation, or information search/retrieval.

“Graph” refers to a representation of one or more tasks and one or more workers as one or more nodes that are connected with each other through one or more links. Hereinafter, the one or more nodes representing the one or more tasks have been referred to as one or more task nodes, and the one or more nodes representing the one or more workers have been referred to as one or more worker nodes. In an embodiment, the one or more task nodes may represent one or more second crowdsourcing tasks. In an embodiment, the one or more worker nodes may represent one or more crowdworkers. On the other hand, a link connecting a task node and a worker node may represent that the crowdsourcing task associated with the task node was previously attempted by the crowdworker associated with the worker node.

“Link” refers to a connection between a task node and a worker node of the graph. In an embodiment, the link connecting the task node and the worker node may represent that the crowdsourcing task associated with the task node was previously attempted by the crowdworker associated with the worker node.

“Weights” refer to one or more values, which are associated with each of the one or more links of the graph. In an embodiment, the weights are computed based on one or more second attributes.

“Degree of similarity” refers to a measure of similarity between the one or more first attributes associated with the first crowdsourcing task and the one or more second attributes associated with the one or more second crowdsourcing tasks. In an embodiment, the measure of similarity may be determined in the form of a distance. In an embodiment, the lower the value of distance computed, higher is the degree of similarity.

“Notification” refers to one or more alerts issued to a crowdworker about the first crowdsourcing task. In an embodiment, the notification can be an email message, an SMS, or a pop-up alert on the interface presented by the crowdsourcing platform on the worker-computing device. A person having ordinary skill in the art would understand that the scope of the disclosure is not limited to the notification as the email message or the SMS message. In an embodiment, the notification may be multimedia message that may be transmitted to the computing device of the crowdworker using any communication medium.

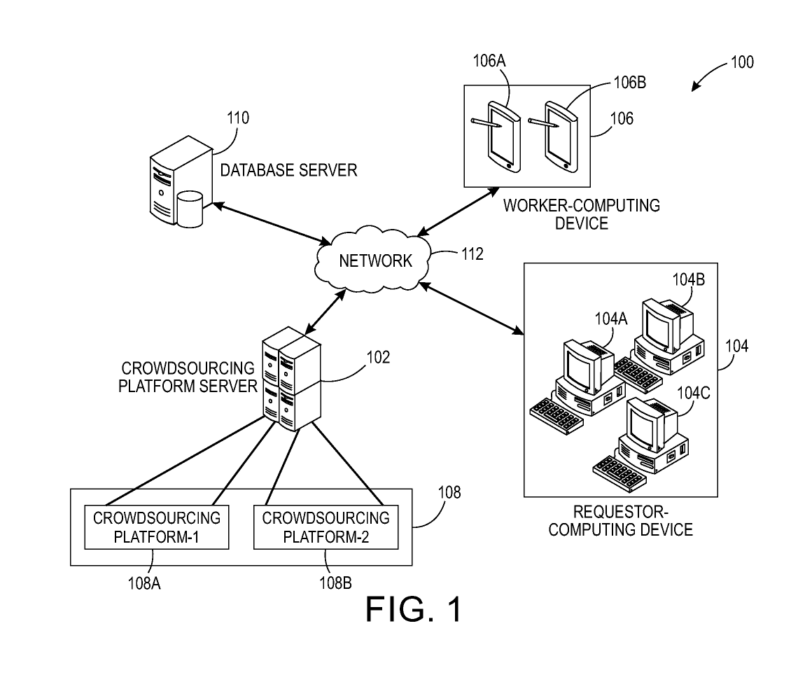

FIG. 1 is a block diagram of a system environment 100, in which various embodiments can be implemented. The system environment 100 includes a crowdsourcing platform server 102, one or more requestor-computing devices 104a, 104b, and 104c (hereinafter collectively referred as a requestor-computing device 104), one or more worker-computing devices 106a and 106b (hereinafter collectively referred as a worker-computing device 106), one or more crowdsourcing platform 108a and 108b (hereinafter collectively referred as a crowdsourcing platform 108), a database server 110, and a network 112. Various devices in the system environment 100 (e.g., the crowdsourcing platform server 102, the requestor-computing device 104, the worker-computing device 106 and the database server 110) may be interconnected over the network 112.

The crowdsourcing platform server 102 refers to a computing device that is configured to host one or more crowdsourcing platforms (e.g., crowdsourcing platform-1 108a and crowdsourcing platform-2 108b, depicted in the system environment 100). In an embodiment, the crowdsourcing platform 108 may receive one or more crowdsourcing tasks from a requestor. In an embodiment, the crowdsourcing platform 108 may further receive one or more first attributes associated with each of the one or more crowdsourcing tasks from a requestor. In an embodiment, the one or more first attributes associated with a first crowdsourcing task of the one or more crowdsourcing tasks may comprise, but are not limited to, a posting time of the first crowdsourcing task, an expiry time of the first crowdsourcing task, a task type associated with the first crowdsourcing task, a unit price associated with the first crowdsourcing task, and a task expertise associated with the first crowdsourcing task.

In an embodiment, the requestor may utilize the requestor-computing device 104 to upload the one or more crowdsourcing tasks on the crowdsourcing platform 108. Thereafter, the crowdsourcing platform 108 may communicate the one or more crowdsourcing tasks (received from the requestor-computing device 104) to the worker-computing device 106 associated with the one or more crowdworkers.

Prior to sending the one or more crowdsourcing tasks to the worker-computing devices 106, the crowdsourcing platform server 102 may extract one or more second crowdsourcing tasks from the database server 110. Further, the crowdsourcing platform server 102 may cluster the one or more second crowdsourcing tasks in one or more sets of second crowdsourcing tasks. In an embodiment, the one or more second crowdsourcing tasks are previously attempted tasks by the one or more crowdworkers. In an embodiment, the crowdsourcing platform server 102 may perform the clustering based on one or more second attributes associated with the one or more second crowdsourcing tasks. In an embodiment, the one or more second attributes may comprise, but are not limited to, information about one or more crowdworkers who had previously attempted the one or more second crowdsourcing tasks, one or more performance metrics associated with the one or more second crowdsourcing tasks, a posting time of the one or more second crowdsourcing tasks, an expiry time associated with the one or more second crowdsourcing task, a task type associated with the one or more second crowdsourcing tasks, a unit price associated with the one or more second crowdsourcing tasks, a task expertise associated with the one or more second crowdsourcing tasks, and a number of attempts associated with the one or more second crowdsourcing tasks.

In an embodiment, the one or more performance metrics refer to at least one of a completion time of the second crowdsourcing task, results/responses of the second crowdsourcing tasks, an accuracy associated with the second crowdsourcing task, and a responding time associated with the second crowdsourcing task.

An embodiment of clustering of one or more second crowdsourcing tasks into the one or more sets of second crowdsourcing tasks is described later in conjunction with FIG. 3.

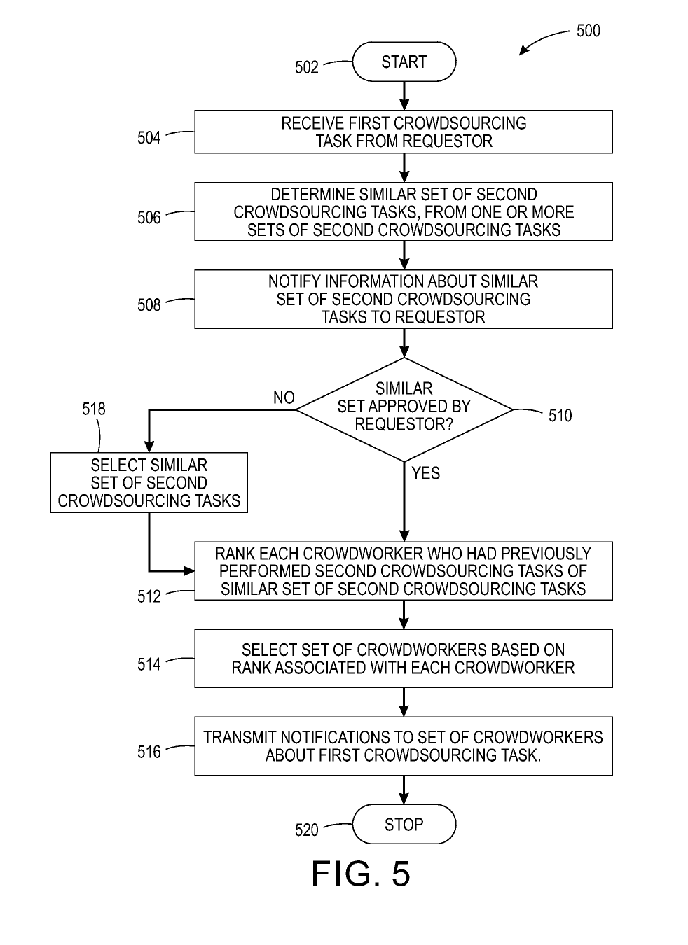

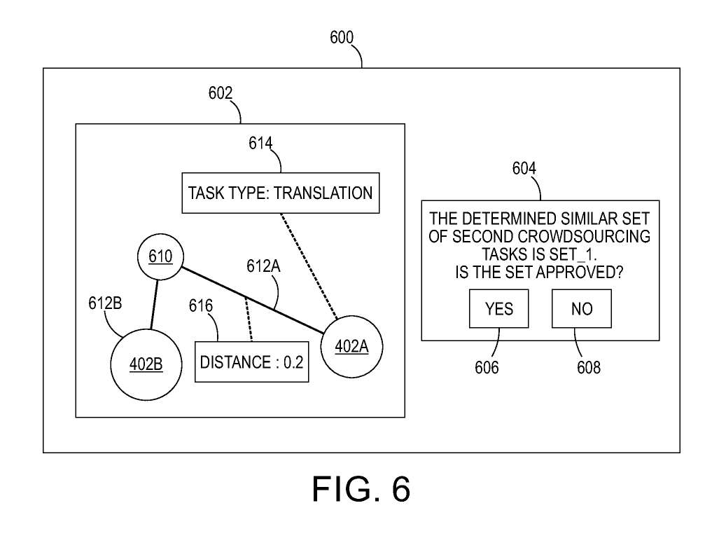

In an embodiment, the crowdsourcing platform server 102 may determine a similar set of second crowdsourcing tasks from the one or more sets of second crowdsourcing tasks. In an embodiment, the crowdsourcing platform server 102 may determine the similar set of second crowdsourcing task based on a degree of similarity computed between a first crowdsourcing task of the one or more crowdsourcing tasks, and each of the one or more sets of second crowdsourcing tasks previously attempted. An embodiment of determining the degree of similarity is described later in conjunction with FIG. 5 and FIG. 6.

In an embodiment, the degree of similarity is computed based on a comparison between one or more first attributes associated with the first crowdsourcing task and the one or more second attributes associated with each of one or more sets of second crowdsourcing tasks.

In an embodiment, the crowdsourcing platform server 102 may recommend the first crowdsourcing task to a set of crowdworkers from the one or more crowdworkers who have previously attempted the determined similar set of second crowdsourcing tasks. In an embodiment, the crowdsourcing platform server 102 may transmit notifications about the first crowdsourcing task to the set of crowdworkers using the crowdsourcing platform 108.

In an embodiment, the notification may be transmitted as an email message to an email ID of the crowdworker. In an embodiment, the email ID of the crowdworker may be retrieved from a crowdworker profile stored in the crowdsourcing platform server 102. In an embodiment, the crowdsourcing platform server 102 may retrieve the email ID of the crowdworker from a crowdworker profile stored in the database server 110. In an embodiment, the set of crowdworkers may receive the notification about the first crowdsourcing task, as a pop up alert on a user interface presented by the crowdsourcing platform 108 on the worker-computing device 106.

The crowdsourcing platform server 102 may be realized through various types of application servers such as, but not limited to, Java application server, .NET framework, and Base4 application server.

The requestor-computing device 104 refers to a computing device used by a requestor. The requestor-computing device 104 may be operable to execute one or more sets of instructions stored in one or more memories. In an embodiment, the requestor-computing device 104 may be communicatively coupled to the network 112. In an embodiment, the requestor may utilize the requestor-computing device 104 to transmit or receive information pertaining to the first crowdsourcing task of the one or more crowdsourcing tasks to/from the crowdsourcing platform server 102 over the network 112. In an embodiment, the requestor-computing device 104 may be used by the requestor, to upload information pertaining to the one or more crowdsourcing tasks on the crowdsourcing platform server 102 over the network 112. In an embodiment, the requestor may access the crowdsourcing platform 108, to upload the information. For example, if the first crowdsourcing task corresponds to the digitization of the handwritten content, the requestor may provide electronic documents that include handwritten content. In an embodiment, the requestor may further provide information pertaining to the one or more first attributes associated with the first crowdsourcing task using the crowdsourcing platform 108.

The requestor-computing device 104 may correspond to a variety of computing devices, such as a desktop, a computer server, a laptop, a personal digital assistant (PDA), a tablet computer, and the like.

The worker-computing device 106 refers to a computing device, used by a crowdworker, to perform the one or more crowdsourcing tasks. In an embodiment, the crowdworker may receive the notification from the crowdsourcing platform server 102 about the first crowdsourcing task of the received one or more crowdsourcing tasks. In an embodiment, the crowdworker may receive the notification for the first crowdsourcing task on a display associated with the worker-computing device 106. Subsequently, the crowdworker may provide input to either accept or reject the first crowdsourcing task. Accordingly, the worker may submit responses to the first crowdsourcing task using the worker-computing device 106. The crowdworker may provide responses using one or more input devices (e.g., keyboard, touch-interface, gesture-recognition, etc.) associated with the worker-computing device 106.

In an embodiment, the crowdworker may create a crowdworker profile using the one or more input devices. In an embodiment, the crowdworker profile may be uploaded on the crowdsourcing platform server 102 using the crowdsourcing platform 108 by the worker-computing device 106. In an embodiment, the crowdworker profile may be uploaded on the database server 110 by the worker-computing device 106.

The worker-computing device 106 may correspond to a variety of computing devices, such as a laptop, a personal digital assistant (PDA), a tablet computer, a smartphone, a phablet, and the like.

In an embodiment, the crowdsourcing platform 108 may present a first interface, which may enable the requestor to interact with the crowdsourcing platform server 102. In an embodiment, the crowdsourcing platform 108 may be hosted on the crowdsourcing platform server 102, as depicted in the system environment 100. In an embodiment, the crowdsourcing platform 108 may be hosted on the requestor-computing device 104.

The crowdsourcing platform 108 may present a second interface on the worker-computing device 106. In an embodiment, the second interface may enable the crowdworker to interact with the crowdsourcing platform server 102 to perform the one or more crowdsourcing tasks.

In an embodiment, the crowdsourcing platform 108 may be hosted on the crowdsourcing platform server 102, as depicted in the system environment 100. In an alternate embodiment, the crowdsourcing platform 108 may be hosted on the worker-computing device 106.

The database server 110 may refer to a computing device that may store the crowdsourcing tasks and corresponding information (i.e., one or more first attributes and one or more second attributes), in accordance with at least one embodiment. The crowdsourcing tasks may comprise the one or more crowdsourcing tasks and the one or more second crowdsourcing tasks. In an embodiment, the database server 110 may be communicatively coupled with the network 112. In an embodiment, the database server 110 may store information pertaining to the one or more first crowdsourcing tasks. In an embodiment, the information pertaining to the one or more crowdsourcing tasks may comprise the one or more first attributes.

In an embodiment, the database server 110 may store information, such as historical data pertaining to the execution of the one or more second crowdsourcing tasks. In an embodiment, the historical data may include, the one or more second attributes associated with the one or more second crowdsourcing tasks. In an embodiment, the historical data may be dynamically updated based on the execution of the one or more second crowdsourcing tasks.

In an embodiment, the database server 110 may further store information pertaining to the one or more crowdworkers. In an embodiment, the information pertaining to the one or more crowdworkers may comprise one or more crowdworker profile. In an embodiment, the crowdworker profile may include information such as, but not limited to, a location of the crowdworker, a gender of the crowdworker, an age of the crowdworker, hobbies of the crowdworker, a marital status of the crowdworker, an expertise associated with each of the one or more crowdworkers, an educational qualification of the crowdworkers, an occupation of the crowdworker, an income level of the crowdworker, an email of the crowdworker, a contact number of the crowdworker, a number of successful tasks and a number of unsuccessful tasks attempted and/or completed by the one or more crowdworkers.

In an embodiment, the database server 110 may obtain the profile information pertaining to the one or more crowdworkers from various sources such as, but not limited to, crowdsourcing platforms, and databases of various organizations that may provide the rightful authentication to access the information pertaining to the one or more crowdworkers.

In an embodiment, the database server 110 may receive a query from the crowdsourcing platform server 102 to retrieve the data pertaining to the one or more crowdsourcing tasks, the one or more second crowdsourcing tasks, and/or the information pertaining to the one or more crowdworkers. For querying the database server 110, one or more querying languages may be utilized such as, but not limited to, SQL, QUEL, DMX and so forth. Further, the database server 110 may be realized through various technologies such as, but not limited to, Microsoft® SQL server, Oracle, and My SQL. In an embodiment, the crowdsourcing platform server 102 may connect to the database server 110 using one or more protocols such as, but not limited to, ODBC protocol and JDBC protocol.

A person skilled in the art would understand that the scope of the disclosure should not be limited to the crowdsourcing platform server 102 and the database server 110 as a separate entity. In an embodiment, the functionalities of the database server 110 and the crowdsourcing platform server 102 may be combined into a single server, without limiting the scope of the disclosure.

The network 112 corresponds to a medium through which content and messages may flow between one or more of, but not limited to the crowdsourcing platform server 102, the requestor-computing device 104, the worker-computing device 106, and/or the database server 110. Examples of the network 112 may include, but are not limited to, a Wireless Fidelity (Wi-Fi) network, a Wide Area Network (WAN), a Local Area Network (LAN), or a Metropolitan Area Network (MAN). Various devices such as the crowdsourcing platform server 102, the requestor-computing device 104, the worker-computing device 106, and/or the database server 110 may connect to the network 112 in accordance with various wired and wireless communication protocols such as Transmission Control Protocol/Internet Protocol (TCP/IP), User Datagram Protocol (UDP), and 2G, 3G, or 4G communication protocols.

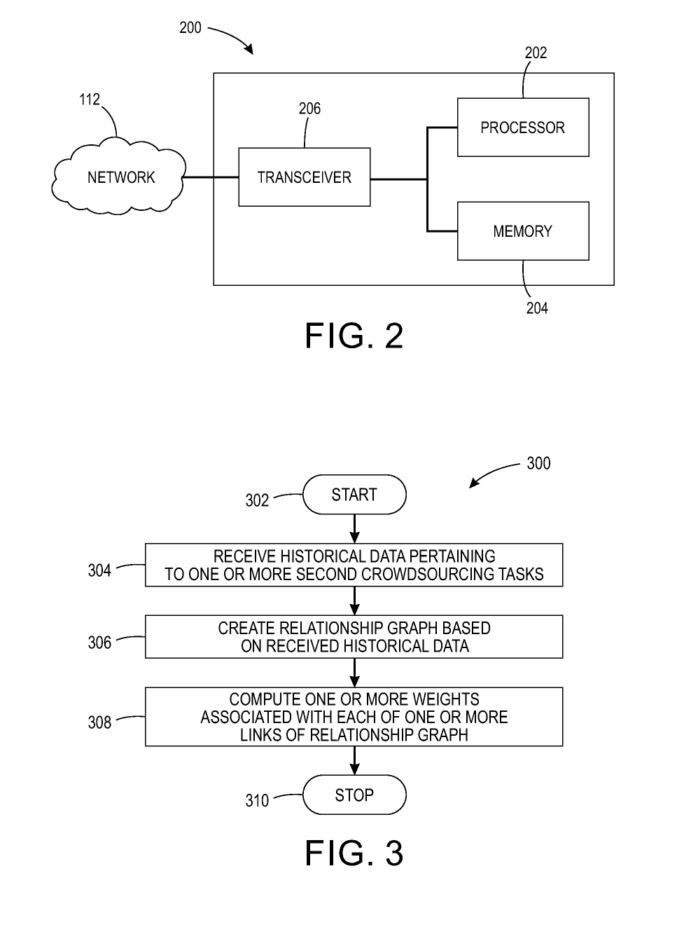

FIG. 2 is a block diagram that illustrates a computing device 200 for recommending one or more crowdsourcing tasks to a crowdworker, in accordance with at least one embodiment. For the purpose of ongoing description, the computing device 200 is considered to be the crowdsourcing platform server 102. However, the scope of the disclosure should not be limited to the crowdsourcing platform server 102. The computing device 200 may also be realized as the requestor-computing device 104 or the worker-computing device 106.

The computing device 200 includes a processor 202, a memory 204, and a transceiver 206. The processor 202 is coupled to the memory 204, and the transceiver 206. The transceiver 206 is connected to the network 112.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other microprocessor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person having ordinary skills in the art that the one or more instructions stored in the memory 204 enables the hardware of the computing device 200 to perform the predetermined operation.

The transceiver 206 transmits and receives messages and data to/from various components of the system environment 100. Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

In an embodiment, the computing device 200 may further comprise a display screen (not shown), when the computing device 200 is implemented as the requestor-computing device 104 and the worker computing device 106. The display screen may comprise suitable logic, circuitry, interfaces, and/or code that may be operable to render a display screen. In an embodiment, the display screen may be realized through several known technologies, such as, Cathode Ray Tube (CRT) based display, Liquid Crystal Display (LCD), Light Emitting Diode (LED) based display, Organic LED display technology, and Retina display technology. In an embodiment, the display screen may be capable of receiving input from the crowdworker (when the system is implemented as the worker computing device 106) or from the requestor (when the system is implemented as the requestor computing device 104). In such a scenario, the display screen may be a touch screen that enables the crowdworker or the requestor to provide input. In an embodiment, the touch screen may correspond to at least one of a resistive touch screen, a capacitive touch screen, or a thermal touch screen. In an embodiment, the display screen may receive input through a virtual keypad, a stylus, a gesture, and/or touch based input.

FIG. 3 is a flowchart 300 illustrating a method for creating a relationship graph from the historical data of the one or more second crowdsourcing tasks, in accordance with at least one embodiment. The flowchart 300 is described in conjunction with FIG. 1 and FIG. 2.

At step 302, the method begins. At step 304, the historical data pertaining to the one or more second crowdsourcing tasks is extracted from the database server 110. In an embodiment, the processor 202 may extract the historical data. In an embodiment, the processor 202 may extract the historical data pertaining to the one or more second crowdsourcing tasks by sending a query to the database server 110. In an embodiment, the query is transmitted using the transceiver 206. The transceiver 206 may further receive the historical data pertaining to the one or more second crowdsourcing tasks from the database server 110. In an embodiment, the historical data may include the one or more second attributes associated with the one or more second crowdsourcing tasks. The following table is example of the historical data pertaining to the one or more second crowdsourcing tasks:

TABLE 1
Illustration of historical data pertaining to one or more second crowdsourcing tasks

| | | | Expected | | | |
|---|---|---|---|---|---|---|
| | | | Completion | | Status of | Task price |
| Task | Task Type | Crowdworkers | Time(hours) | Accuracy | submission | (USD) |
| Task_1 | Translation | Worker_1, | 1 | 90 | Approved | 1 |
| Task_1 | Translation | Worker_3, | 1 | 30 | Approved | 1 |
| Task_1 | Translation | Worker_3, | 1 | 40 | Approved | 1 |
| Task_1 | Translation | Worker_1, | 1 | 20 | Rejected | 1 |
| Task_2 | Photo Tagging | Worker_2, | 2 | 50 | Rejected | 2 |
| Task_2 | Photo Tagging | Worker_4 | 2 | 60 | Approved | 2 |
| Task_3 | Translation | Worker_1, | 3 | 80 | Approved | 2.5 |
| Task_3 | Translation | Worker_1 | 3 | 40 | Rejected | 2.5 |
| Task_4 | Translation | Worker_5 | 1 | 50 | Approved | 2 |
| Task_4 | Translation | Worker_5 | 1 | 90 | Approved | 2 |
| Task_5 | Photo Tagging | Worker_4 | 3 | 10 | Rejected | 3 |

At step 306, a relationship graph is created based on the received historical data. In an embodiment, the processor 202 may create the relationship graph. In an embodiment, the relationship graph may include one or more task nodes, one or more worker nodes, and one or more links connecting the one or more task nodes and the one or more worker nodes.

In an embodiment, each of the one or more task nodes may represent a second crowdsourcing task from the one or more second crowdsourcing tasks. In an embodiment, each of the one or more worker nodes may represent a crowdworker from the one or more crowdworkers who have attempted the one or more second crowdsourcing tasks.

In an embodiment, a first link of the one or more links between a first task node and a first worker node may represent that the second crowdsourcing task associated with the first task node was performed by the crowdworker associated with the first worker node.

For instance, a first link is formed between the first task node “Task_1” and a first worker node “Worker_1”. Similarly, a second link is formed between the first task node “Task_2” and a second worker node “Worker_4”. In an embodiment, if more than one workers had performed a Task_1, the processor 202 may define more than one links for the Task_1. For example, if the Task_1 is performed by the Worker_1 and Worker_3. Then, processor 202 may place a link between the Task_1 and Worker_1. Further, the processor 202 may place a link between the Task_1 and Worker_3.

In an embodiment, the one or more second tasks may be clustered in one or more sets of second crowdsourcing tasks. In an embodiment, the processor 202 may cluster the one or more second crowdsourcing tasks based on the one or more second attributes associated with each of the one or more second crowdsourcing tasks. For example, “Task_1” has a task type of “Translation”. Further, the task type of “Task_3” and “Task_4” is same as the task type of “Task_1”. Therefore, the processor 202 clusters “Task_1”, “Task_3”, and “Task_4” in a “Set_1”. Similarly, as seen from the Table 1, the task type of “Task_2” and “Task_5” is same, i.e., “Photo Tagging”, so the processor 202 may clusters “Task_2” and “Task_5”, in a “Set_2”.

In an embodiment, the requestor may provide input through the user interface, to define or select at least one second attribute from the one or more second attributes, based on which the one or more second tasks are to be clustered. In an embodiment, the processor 202 may cluster the one or more second tasks, based on the selected attributes. For example, the requestor selects the at least one second attribute as the “task duration”. Then the processor 202 may cluster Task_1, and Task_4 in a single cluster having a task duration of 1 hour, and so on.

In an embodiment, the processor 202 may represent the clusters as the node in the relationship graph. In an embodiment, in each of the one or more nodes, the processor 202 may display one or more sub-nodes to represent the tasks encompassed in the cluster. In an embodiment, the node may be linked to the one or more workers, who have worked on the task encompassed by the node.

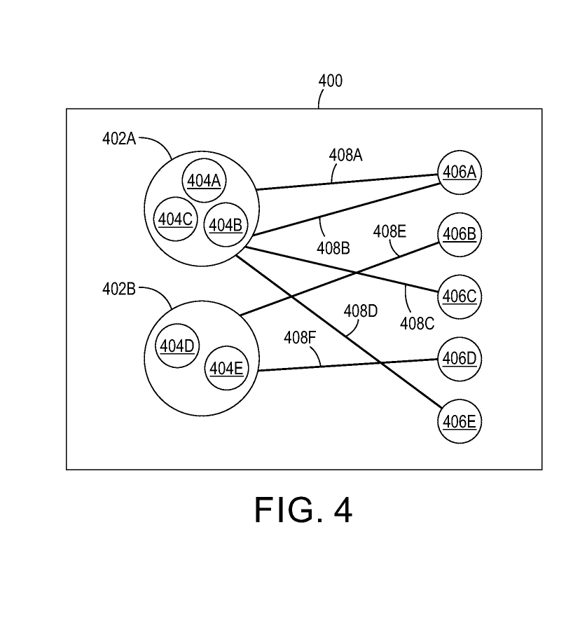

The relationship graph has been described later in conjunction with FIG. 4. It will be apparent to a person having ordinary skill in the art that the above Table 1 has been provided only for illustration purposes and should not limit the scope of the disclosure.

In an embodiment, the requestor may select a plurality of the one or more second attributes to cluster the one or more second crowdsourcing tasks into the one or more set of second crowdsourcing tasks. For example, both the attributes of “Task Type” and “Expected Task Completion Time” may be utilized to cluster the one or more second crowdsourcing tasks into the one or more set of second crowdsourcing tasks.

At step 308, one or more weights for each of the one or more links may be computed. In an embodiment, the processor 202 computes the one or more weights based on the historical data pertaining to the one or more second crowdsourcing tasks.

In an embodiment, the processor 202 may compute a weight associated with an ith crowdworker if the submission for the second crowdsourcing task j^{th} is approved, using the expression (1) given below:

W′ᵢⱼ=Wᵢⱼ+α₁(1−Wᵢⱼ) (1)

where,

Wᵢⱼ represents the original weight of the i^{th} crowdworker associated with the j^{th} second crowdsourcing task performed by the i^{th} crowdworker,

W′ᵢⱼ represents the new weight computed after the ith crowdworker submission on j^{th} second crowdsourcing task is approved, and

α₁ represents a coefficient to adjust the increase\decrease of weights.

In an embodiment, the processor 202 may compute a weight associated with an ith crowdworker if the submission for the second crowdsourcing task j^{th} for the crowdsourcing task of the second crowdsourcing task is rejected, using the expression (2) given below:

W′ᵢⱼ+Wᵢⱼ+α₂(0−Wᵢⱼ) (2)

where,

Wᵢⱼ represents the original weight of the i^{th} crowdworker associated with the j^{th} second crowdsourcing task performed by the i^{th} crowdworker,

W′ᵢⱼ represents the new weight computed after the i^{th} crowdworker submission on j^{th} second crowdsourcing task is rejected, and

α₂ represents a coefficient to adjust the increase\decrease of weights.

In an embodiment, the processor 202 may decay a weight associated with an ith crowdworker and the j^{th} second crowdsourcing task to reflect the fact that the most recent events reflect the current status of the system, while the oldest event may not capture the current status, using the expression (3) below.

Wᵢⱼ^{t+1}=δWᵢⱼ^{t} (3)

where,

Wᵢⱼ^{t+1} represents the weight of the i^{th} crowdworker associated with the j^{th} second crowdsourcing task performed by the i^{th} crowdworker at the next time t+1,

Wᵢⱼ^{t} represents the weight of the ith crowdworker associated with the j^{th} second crowdsourcing task performed by the i^{th} crowdworker at time t, and

δ represents a decay coefficient less than 1.

In an embodiment, each weight of the one or more weights may represent either a value or a vector composed of a set of the one or more second attributes. For example, each weight may be computed based on only the accuracy for a first crowdworker processing a second crowdsourcing task of the set of the one or more second crowdsourcing tasks. In an embodiment, a value of the weight of the one or more weights may range between 0 and 1.

In an embodiment, for the first iteration, the weights for each of the one or more links in the relationship graph is considered to be “0”. Thereafter, based on the data obtained from the historical data, the one or more weights are updated.

For example, a first weight is computed for the first link between the first task node (“Set_1”) and the first worker node (“Worker_1”). In an event, where the “Worker_1” has submitted a first submission of the task “Task_1” of “Set_1” having an accuracy of 90% and the first submission has been approved, the processor 202 computes the value of the first weight using the expression (1). In such an embodiment, the value of α₁ corresponds to the value of accuracy, i.e., 0.9, thus the value of first weight changes from “0” to “0.9”.

Furthermore, from the historical data of Table 1, a second submission for the first task “Task_1” by the crowdworker “Worker_1” is rejected with an accuracy of 20%. In such an embodiment, the processor 202 again computes the value of the first weight using the expression (2). In such an embodiment the value of α₂ corresponds to the value of 1−α₁, i.e., 0.8, thus the value of weight changes from “0.9” to “0.18”. Thus in an embodiment, the value of the first weight will be updated dynamically based on the submissions made by “worker_1” for the task “Task_1”.

A person having ordinary skill in the art would understand that the scope of the disclosure is not limited to determining the weights based on the accuracy. In an embodiment, various other second attributes may be used to determine the weights. In an embodiment, combination of any of the one or more second attributes may be used to determine the weights.

Further, it will be apparent to a person having ordinary skill in the art that the above mentioned techniques have been provided only for illustration purposes and should not limit the scope of the disclosure. In an embodiment, the processor 202 may employ different techniques for computing the one or more weights, without departing from the scope of the disclosure.

FIG. 4 depicts a graphical representation of the relationship graph 400, in accordance with at least one embodiment. The relationship graph 400 is described with respect to the method disclosed in FIG. 3.

The relationship graph 400 includes one or more task nodes 402a, 402b (collectively referred as 402), one or more sub-nodes 404a, 404b, 404c, 404d and 404e (collectively referred as 404), one or more worker nodes 406a, 406b, 406c, 406d, 406e (collectively referred as 406), and one or more links 408a, 408b, 408c, 408d, 408e, and 408f (collectively referred as 408).

In an embodiment, the one or more task nodes 402 represent the one or more sets of second crowdsourcing tasks. With respect to the example illustrated based on Table 1, a first task node 402a and a second task node 402b represent “Set_1” and “Set_2”, respectively.

In an embodiment, a task node 402 may comprise the one or more sub-nodes 404. In an embodiment, a first sub-node 404a of the one or more sub-nodes 404 may represents task_1 (refer table 1). Further, the task_3 may be represented by the node 404b, and so on.

Similarly, the second task node 402b further comprises a fourth sub-node 404d that represents “Task_2” and a fifth sub-node 404e represents “Task_5”.

In an embodiment, the one or more worker nodes 406 represent the one or more crowdworkers who have attempted the one or more second crowdsourcing tasks. For example, a first worker node 406a, a second worker node 406b, a third worker node 406c, a fourth worker node 406d, and a fifth worker node 406e represent “Worker_1”, “Worker_2”, “Worker_3”, “Worker_4”, and “Worker_5”, respectively.

Based on the historical data provided in Table 1, it is apparent that the “Worker_1” has performed the “Task_1” of the “Set_1” represented by the first task node 402a, as a first link 408a links the first task node 402a and the first worker node 406a. Since, “Worker_1” has further performed “Task_3” of “Set_1”, a second link 408b links the first task node 402a and the first worker node 406a. Similarly, since the “Worker_3” has performed the “Task_1” of the “Set_1” represented by the first task node 402a, a third link 408c links the first task node 402a and the third worker node 406c. Further, as the “Worker_5” has performed the “Task_4” of the “Set_1”, a fourth link 408d links the first task node 402a and the fifth worker node 406e. Similarly, a fifth link 408e links the second task node 402b and the second worker node 406b, while a sixth link 408f links the second task node 402b and the fourth worker node 406d.

It will be apparent to a person having ordinary skill in the art that the above mentioned graph has been provided for illustration purposes and should not limit the scope of the disclosure. In an embodiment, the relationship graph 400 may have different illustrations, without departing from the scope of the disclosure.

FIG. 5 is a flowchart 500 illustrating a method for recommending the one or more crowdsourcing tasks, in accordance with at least one embodiment. The flowchart 500 is described in conjunction with FIG. 1, FIG. 2, FIG. 3, and FIG. 4.

At step 502, the method begins. At step 504, a first crowdsourcing task of the one or more crowdsourcing tasks may be received. In an embodiment, the transceiver 206 receives the first crowdsourcing task from the requestor-computing device 104 via the network 112. In an embodiment, the transceiver 206 transmits the received first crowdsourcing task to the processor 202.

In an embodiment, the one or more first attributes may be received along with the first crowdsourcing task. In an embodiment, the requestor provides the one or more first attributes associated with the first crowdsourcing task using the requestor-computing device 104. In an embodiment, the one or more first attributes may include, but are not limited to, a posting time of the first crowdsourcing task, an expiry time of the first crowdsourcing task, a task type associated with the first crowdsourcing task, a unit price associated with the first crowdsourcing task, and a task expertise associated with the first crowdsourcing task.

For example, Table 2 shows the one or more first attributes received from the requestor.

TABLE 2
Illustration of one or more first attributes of the
first crowdsourcing task.

| | | Posting | Expected | Expiry | Task |
|---|---|---|---|---|---|
| | | time | Completion | time | price |
| Task | Task Type | (hours) | time (hours) | (Hours) | (USD) |
| New_Task | Translation | 10 | 1 | 14 | 1 |

It will be apparent to a person skilled in the art that the processor 202 may also receive the one or more first attributes associated with the first crowdsourcing task from the database server 110, without departing from the scope of the disclosure.

At step 506, a similar set of second crowdsourcing tasks may be determined from the one or more sets of second crowdsourcing tasks. In an embodiment, the similar set of second crowdsourcing tasks may be determined based on a degree of similarity between the first crowdsourcing task and each of the one or more sets of second crowdsourcing tasks (the one or more sets of second crowdsourcing task are obtained by clustering the one or more second crowdsourcing tasks based the method explained with respect to FIG. 3 and FIG. 4).

In an embodiment, the degree of similarity between the first crowdsourcing task and one of the one or more sets of second crowdsourcing tasks may be determined by computing a distance between the one or more first attributes associated with the received first crowdsourcing task and the one or more second attributes associated with the one or more second crowdsourcing tasks. In an embodiment, a lower value of the computed distance corresponds to a higher value of the degree of similarity.

In an embodiment, the processor 202 may compute the distance between the first crowdsourcing task and each of the one or more set of second crowdsourcing tasks by using the following equation:

dⱼ=min(d_{n,k}) k=1,2, . . . Nⱼ (4)

where,

dⱼ is the minimum distance between the first crowdsourcing task n and a set j of one or more sets of second crowdsourcing tasks,

d_{n,k} is the distance between the first crowdsourcing task n and a second crowdsourcing task k of the set of second crowdsourcing task j, and

Nⱼ is the total number of second crowdsourcing tasks in the set j.

In an embodiment, the processor 202 may compute the value of d_{n,k} using the expression (5) given below:

$${d}_{n , k} = \sqrt{{\sum }_{l = 1}^{M} {( \frac{{γ}_{k , l} - {γ}_{n , l}}{max ( {γ}_{k , l} , {γ}_{n , l} )} )}^{2}} \qquad ( 5 )$$

where,

d_{n,k} is the distance between the first crowdsourcing task n and a second crowdsourcing task k of the set of second crowdsourcing task j,

γ_{k,l} represents the I^{th} attribute related to task k,

γ_{n,l} represents the I^{th} attributes related to task n, and

M is the total number of attributes of a task.

For example, in an embodiment the processor 202 receives the first crowdsourcing task that corresponds to a parking video task. In such a scenario, the one or more attributes of the received task may include, but are not limited to, a video speed, a video duration, a video timing, a life time of the parking video task, an assignment duration, an incentive, and a crowdworker qualification requirements. In an embodiment, the processor 202 may compute the distance d_{n,k} based on each of the seven attributes (M=7), i.e., the video speed, the video duration, the video timing, the life time of the parking video task, the assignment duration, the incentive, and the crowdworker qualification requirements.

Referring to example illustrated using Table 1, where the “Task_1”, the “Task_2”, the “Task_3”, the “Task_4”, and the “Task_5” are the one or more second crowdsourcing tasks. In the above example, based on the method steps described with respect to FIG. 3, the tasks “Task_1”, “Task_2”, “Task_3”, “Task_4”, and “Task_5” may be clustered into two sets “Set_1” and “Set_2” (already explained with respect to FIG. 3).

In order to determine the distance of a “New Task” from each of the one or more clusters, the processor 202 may first determine distance of the “New task” from each task in each cluster individually. For example, the processor 202 computes the distances d_{1,1-1}, d_{1,1-2}, d_{1,1-3} between a “New_Task” and each of the “Task_1”, “Task_3” and “Task_4”, respectively, using the equation (5). Hereinafter, d_{1,1-1} denotes a distance of the New_Task from the Task_1 within a cluster of tasks, i.e., the Set_1, and so on. Similarly, the processor 202 computes the distance between the “New Task” and the “Task_3” and “Task_4” the distances d_{1,1-2}, and d_{1,1-3}, respectively. Thereafter, the processor 202 considers the minimum distance among the distances d_{1,1-1}, d_{1,1-2}, and d_{1,1-3} as the distance between the “New_Task” and the Set-1 (i.e., 0.2). In an alternate embodiment, the processor 202 may determine the distance d₁ as a distance of the New_Task from a centroid (denoted by d_{1,1}) of the tasks clustered in the “Set_1”. For instance, in the above example, the processor 202 may determine the distance d₁ as a mean of the distances d_{1,1-1}, d_{1,1-2}, d_{1,1-3} as the distance of the New_Task from the centroid of the Set_1 (i.e., d_{1,1}). Thus, the processor 202 may determine the value of the distance d_{1,1} (and thus the distance d₁ from the Set_1) as (0.6+0.3+0.2)/3, i.e., 0.367.

Further, the number of second crowdsourcing tasks clustered as “Set_2” is two, i.e., “Task_2” and “Task_5”. In such a scenario, the processor 202 computes the distance d_{1,2-1} and d_{1,2-2} between the “New_Task” and each task in the Set_2, i.e., the “Task_2” and “Task_5”, respectively, using the equation (5). In an embodiment, the processor 202 computes the distance d₂ as a minimum value among the distances d_{1,2-1} and d_{1,2-2} and using the equation (4). For example, if the values of d_{1,2-1} and d_{1,2-2} are 0.8 and 0.9 respectively, the processor 202 may determine the value of the distance d₂ as 0.8. In another embodiment, the processor 202 may determine the distance d₂ as a distance of the New_Task from a centroid (denoted by d_{1,2}) of the tasks clustered in the Set_2. In an embodiment, the processor 202 may determine d_{1,2} (and hence the value of the distance d₂) as a mean of the distances d_{1,2-1} and d_{1,2-2}. For instance, in the above scenario, the processor 202 may determine the value of d_{1,2} (and thus the distance d₂ from the Set_2) as (0.8+0.9)/2, i.e., 0.85.

In such a scenario, the processor 202 may determine that the tasks in the “Set_1” have a lower value of distance to the “New_Task” as compared to the tasks in the “Set_2”, since the value of distance d₁ determined for the Set_1 is less than the value of distance d₂ determined for the Set_2.

It will be apparent to a person having ordinary skill in the art that the aforementioned techniques have been provided only for illustration purposes and should not limit the scope of the disclosure. In an embodiment, the processor 202 may employ different techniques for computing the degree of similarity, and the distance between the first crowdsourcing task, and a second crowdsourcing task of the one or more second crowdsourcing tasks, without departing from the scope of the disclosure.

At step 508, the requestor may be notified about the determined similar set of second crowdsourcing tasks. In an embodiment, the crowdsourcing platform 108 may present a notification about the determined similar set of second crowdsourcing tasks on the first user interface to the requestor. In an embodiment, the first user interface may be presented on the requestor-computing device 104.

In an embodiment, the first user interface displays the distances computed between the new task and the one or more sets of second crowdsourcing tasks. In an embodiment, the first user interface displays a notification that may inform the requestor about the determined similar set of second crowdsourcing tasks having a minimum computed distance among the distances computed between the new task and the one or more sets of second crowdsourcing tasks.

In an embodiment, the first user interface may further include a first option “Yes”, and a second option “No”. More details about the first user interface presented on the requestor-computing device 104 is explained in conjunction with FIG. 6.

At step 510, a check is made whether the requestor approved the determined similar set of second crowdsourcing tasks. In an embodiment, the requestor may select the first option “YES” to approve the determined set of second crowdsourcing tasks.

In an event when the check is validated, i.e., the requestor approves the determined similar set of second crowd sourcing tasks, the control moves to step 512.

At step 512, each of the crowdworkers who have previously performed the second crowdsourcing tasks of the similar set of second crowdsourcing tasks may be ranked. In an embodiment, the processor 202 may rank each of the crowdworkers based on the one or more performance metrics in the historical data.

In an embodiment, the processor 202 determines, from the relationship graph, the information about the one or more crowdworkers who have performed the one or more second crowdsourcing tasks of the similar set of second crowdsourcing tasks. In an embodiment, the processor 202 may retrieve the relationship graph from the database server 110.

For example, the similar set of second crowdsourcing tasks “Set_1” is approved by the requestor in step 512. Thus, the processor 202 will retrieve information about the one or more crowdworkers who had performed the second crowdsourcing tasks the “Task_1”, the “Task_3” and the “Task_4” from the relationship graph 400, created based on the historical data (Refer to Table 1). In such an embodiment, from the relationship graph 400 it is determined that “Worker_1”, “Worker_3”, and “Worker_5” have performed the “Task_1”, “Task_3” and “Task_4” of the “Set_1”.

In an embodiment, the processor 202 may rank each of the crowdworkers based on one or more performance metrics associated with the crowdworker for the performed second crowdsourcing task. In an embodiment, the processor 202 obtains the one or more performance metrics from the retrieved historical data.

As the one or more performance metrics are utilized to compute the one or weights of the relationship graph, therefore weights may be utilized to rank the one or more crowdworkers.

With reference to the example illustrated in the relationship graph 400, the one or more weights are computed based on the accuracy associated with the second crowdsourcing tasks. For instance, the first link 408a may correspond to a first weight having a value “0.8”. Similarly, the second link 408b may correspond a second weight having a value “0.4”, the third link 408c may correspond to a third weight having a value “0.6”, and the fourth link 408d may correspond to a fourth weight having a value “0.6”. Table 3 illustrates the one or more weights associated with the one more crowdworkers who performed the tasks of “Set_1”.

TABLE 3
Illustration of the one or more weights associated with the
set of second crowdsourcing task and the one or more
crowdworkers performing the set of second crowdsourcing task.

| | Worker | | |
|---|---|---|---|
| Task | Worker 1 | Worker 3 | Worker 5 |
| Task_1 | 0.8 | 0.4 | — |
| Task_3 | 0.6 | — | — |
| Task_4 | — | — | 0.6 |

It will be apparent to a person having ordinary skill in the art that the above-mentioned techniques have been provided only for illustration purposes and should not limit the scope of the disclosure.

In an embodiment, the processor 202 may rank the one or more crowdworkers based on the one or more weights associated with each link of the relationship graph. In an embodiment, the processor 202 may rank the one or more crowdworkers in an increasing order of the one or more weights. For example as illustrated in the Table 3, Worker_1 has a highest weight for the Task_1 and the Task_3. Hence, the Worker_1 may be assigned the highest rank for the Task_1 and the Task_3.

In an embodiment, the processor 202 may rank the one or more crowdworkers in a decreasing order of the one or more weights. For example as illustrated in the Table 3, Worker_1 will have the highest rank, i.e., 1. Table 4 illustrates the rank of each of the set of crowdworker based on the one or more weights obtained from Table 3.

TABLE 4
Illustration of ranks associated with each of the one or more
workers based on the one or more weights.

| Worker | Rank |
|---|---|
| Worker_1 | 1 |
| Worker_3 | 3 |
| Worker_5 | 2 |

At step 514, a set of crowdworkers may be selected based on the rank associated with each of the crowdworker of the set of crowdworkers. In an embodiment, the processor 202 may select the set of crowdworkers based on a predetermined criteria. In an embodiment, the predetermined criteria may be a threshold. For example, the set of crowdworkers may contain each of the one or more crowdworkers having rank less than two. In such an embodiment, the set of crowdworkers will include “Worker_1” and “Worker_5”.

In an embodiment, the requestor may provide the information about the predetermined criteria using the first interface presented by the crowdsourcing platform 108.

At step 516, the processor 202 may transmit one or more notifications pertaining to the first crowdsourcing task to the selected set of crowdworkers. In an embodiment, the one or more notifications may correspond to a notification via an email, or a notification via an SMS/call. In an embodiment, the email address and the mobile number may be retrieved from the crowdworker profile retrieved from the memory 204. In an embodiment, the one or more crowdworkers profiles may be extracted from the database server 110.

In an embodiment, a crowdworker from the selected set of crowdworkers may perform the first crowdsourcing task. In an embodiment, the processor 202 may determine one or more performance metrics of the crowdworker on the first crowdsourcing task based on a performance of the crowdworker on the first crowdsourcing task. In an embodiment, the one or more performance may include, but are not limited to, a completion time, a responding time, and an accuracy associated with said first crowdsourcing task. Further, the processor 202 may determine how frequently the crowdworker performs the first crowdsourcing task. For example, if the crowdworker submits responses to the first crowdsourcing task twice, the processor 202 determines that the frequency of the crowdworker performing the first crowdsourcing task is 2. In an embodiment, the processor 202 may dynamically update the one or more weights in the graph representing the crowdworker and the one or more tasks performed by the crowdworker, based on the performance of the crowdworker on the first crowdsourcing task and the frequency of the crowdworker performing the first crowdsourcing task, in a manner similar to the determination of the one or more weights explained in the step 308 (FIG. 3). For example, the processor 202 may use the equations 1 and 2 to update the one or more weights based on the performance of the crowdworker on the first crowdsourcing task. Further, the processor 202 may use the equation 3 to update the one or more weights based on the frequency of the crowdworker performing the first crowdsourcing task.

In the event if at step 510, the check is invalidated, i.e., it is determined that the requestor has rejected the determined similar set of second crowdsourcing tasks, the control moves to step 518. The method ends at step 520.

At step 518, a similar set of second crowdsourcing tasks from the one or more sets of second crowdsourcing tasks that are displayed on the first user interface may be selected by the requestor. In an embodiment, the requestor selects the similar set of second crowdsourcing tasks based on the one or more second attributes associated with each of the one or more sets of second crowdsourcing tasks. Once the requestor selects the similar set of second crowdsourcing tasks, the control moves to step 512.

FIG. 6 illustrates an exemplary embodiment of the first user interface 600 presented on the requestor-computing device 104 by the crowdsourcing platform 108.

The first user interface 600 is presented to the requestor on the requestor-computing device 104 by the crowdsourcing platform 108. The first user interface 600 includes a distance graph 602, a display portion 604, a first option 606, and a second option 608. The distance graph 602 comprises an input node 610, the one or more task nodes 402, and one or more distance links 612a, 612b (collectively referred as 612). In an embodiment, the display portion 604 displays a notification indicating the determined similar set of second crowdsourcing tasks (as described in FIG. 5). In an embodiment, the notification may be displayed on the display portion 604, as “The determined similar set of second crowdsourcing tasks is Set_1. Is the set approved?”

In an embodiment the first option 606 and the second option 608 enables the requestor to provide an input. The input may correspond to the approval/rejection of the determined similar set of second crowdsourcing tasks. In an embodiment, the first option 606 may correspond to a “YES” button. In an embodiment, the second option 608 may correspond to a “NO” button.

When the requestor hovers or clicks on a first task node (e.g., 402a) from the one or more task nodes 402, a window 614 is displayed to the requestor. The window 614 displays the one or more second attributes corresponding to the second crowdsourcing task associated with the first task node 402a.

Similarly, when the requestor hovers over a distance link (e.g., 612a) connecting a task node (e.g., 402a) and the input node 610, a window 616 is displayed. The window 616 displays information regarding computed distance between the input node 610 and the first task node 402a.

Based on the input received from the requestor using the first option 606 or the second option 608, the similar set of second crowdsourcing tasks is determined as described in FIG. 5.

The disclosed embodiments encompass numerous advantages. Through various embodiments for recommending crowdsourcing tasks, the crowdworkers are notified about new tasks posted by requestors, which are similar to previous tasks performed by the crowdworkers. Performing such tasks may leverage the expertise of the crowdworkers and may result in improved performance on the crowdsourcing tasks. Furthermore, the requestor may provide the attributes, based on which they want to recommend the posted crowdsourcing task to the set of crowdworkers.

Further, it is disclosed that the crowdworkers are recommended the tasks based on their prior performances. As discussed, a crowdworker may be notified about a new task, which is similar to a previous task performed by the worker with high accuracy. Hence, as the new task is similar to a previous task on which the crowdworker's performance was of high accuracy, the crowdworker is highly likely to perform well on the new task as well.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, Java, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for recommending crowdsourcing tasks have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for recommending crowdsourcing tasks to one or more crowdworkers, said method comprising:
receiving, by one or more processors, a first crowdsourcing task from a requestor;
determining, by said one or more processors, a set of second crowdsourcing tasks, from one or more sets of second crowdsourcing tasks previously attempted by one or more crowdworkers, based on a degree of similarity between said first crowdsourcing task and each of said one or more sets of second crowdsourcing tasks, wherein said degree of similarity is determined based on a comparison between one or more first attributes associated with said first crowdsourcing task and one or more second attributes associated with each of said one or more sets of second crowdsourcing tasks; and
recommending, by said one or more processors, said first crowdsourcing task to a set of crowdworkers from said one or more crowdworkers based on performance of said set of crowdworkers on said set of second crowdsourcing tasks.

2. The method of claim 1, wherein said one or more first attributes and said one or more second attributes correspond to at least one of a posting time of a crowdsourcing task, an expiry time of a crowdsourcing task, a task type associated with a crowdsourcing task, a unit price associated with a crowdsourcing task, and a task expertise associated with a crowdsourcing task.

3. The method of claim 1, wherein said one or more sets of second crowdsourcing tasks are obtained by clustering one or more crowdsourcing tasks based on at least said degree of similarity among said one or more crowdsourcing tasks, wherein said one or more crowdsourcing tasks are previously attempted by said one or more crowdworkers.

4. The method of claim 3 further comprising creating, by said one or more processors, a graph representative of one or more links between each of said one or more crowdworkers and said one or more crowdsourcing tasks, wherein each link between a crowdworker and a crowdsourcing task represents that said crowdsourcing task was processed by said crowdworker.

5. The method of claim 4 further comprising assigning, by said one or more processors, one or more weights to each of said one or more links based on one or more performance metrics of said one or more crowdworkers on said one or more crowdsourcing tasks.

6. The method of claim 5, wherein said one or more performance metrics comprises at least one of one or more of a completion time associated with a crowdsourcing task, a responding time associated with said crowdsourcing task, and an accuracy associated with said crowdsourcing task.

7. The method of claim 5 wherein said one or more weights are updated dynamically based on a performance of said crowdworker on said first crowdsourcing task and a frequency of said crowdworker performing said first crowdsourcing task.

8. The method of claim 5 further comprising ranking, by said one or more processors, each crowdworker of said one or more crowdworkers based on a weight associated with said one or more links corresponding to said one or more crowdworkers, wherein said first crowdsourcing task is recommended to said one or more crowdworkers based on said rank.

9. The method of claim 1 further comprising transmitting notifications, by said one or more processors to said set of crowdworkers about said first crowdsourcing task.

10. A system for recommending crowdsourcing tasks to one or more crowdworkers, said system comprising:
one or more processors configured to:
receive a first crowdsourcing task from a requestor;
determine a set of second crowdsourcing tasks, from one or more sets of second crowdsourcing tasks previously attempted by one or more crowdworkers, based on a degree of similarity between said first crowdsourcing task and each of said one or more sets of second crowdsourcing tasks, wherein said degree of similarity is determined based on a comparison between one or more first attributes associated with said first crowdsourcing task and one or more second attributes associated with each of said one or more sets of second crowdsourcing tasks; and
recommend said first crowdsourcing task to a set of crowdworkers from said one or more crowdworkers based on performance of said set of crowdworkers on said set of second crowdsourcing tasks.

11. The system of claim 10, wherein said one or more first attributes and said one or more second attributes correspond to at least one of a posting time of a crowdsourcing task, an expiry time of a crowdsourcing task, a task type associated with a crowdsourcing task, a unit price associated with a crowdsourcing task, and a task expertise associated with a crowdsourcing task.

12. The system of claim 10, wherein one or more sets of second crowdsourcing tasks are obtained by clustering one or more crowdsourcing tasks based on at least said degree of similarity among said one or more crowdsourcing tasks, wherein said one or more crowdsourcing tasks are previously attempted by said one or more crowdworkers.

13. The system of claim 12, wherein said one or more processors are configured to create a graph representative of one or more links between each of said one or more crowdworkers and said one or more crowdsourcing tasks, wherein each link between a crowdworker and a crowdsourcing task represents that said crowdsourcing task was processed by said crowdworker.

14. The system of claim 13, wherein said one or more processors are configured to assign one or more weights to each of said one or more links based on one or more performance metrics of said one or more crowdworkers on said one or more crowdsourcing tasks.

15. The system of claim 14, wherein said one or more performance metrics comprises at least one of one or more of a completion time associated with a crowdsourcing task, a responding time associated with said crowdsourcing task, and an accuracy associated with said crowdsourcing task.

16. The system of claim 14, wherein said one or more weights are updated dynamically based on a performance of said crowdworker on said first crowdsourcing task and a frequency of said crowdworker performing said first crowdsourcing task.

17. The system of claim 14, wherein said one or more processors are configured to rank each crowdworker of said one or more crowdworkers based on a weight associated with said one or more links corresponding to said one or more crowdworkers, wherein said first crowdsourcing task is recommended to said one or more crowdworkers based on said rank.

18. The system of claim 10, wherein said one or more processors are configured to transmit notifications to said set of crowdworkers about said first crowdsourcing task.

19. A computer program product for use with a computing device, the computer program product comprising a non-transitory computer readable medium, the non-transitory computer readable medium stores a computer program code for recommending crowdsourcing tasks, the computer program code is executable by one or more processors in the computing device to:
receive a first crowdsourcing task from a requestor;
determine a set of second crowdsourcing tasks, from one or more sets of second crowdsourcing tasks previously attempted by one or more crowdworkers, based on a degree of similarity between said first crowdsourcing task and each of said one or more sets of second crowdsourcing tasks, wherein said degree of similarity is determined based on a comparison between one or more first attributes associated with said first crowdsourcing task and one or more second attributes associated with each of said one or more sets of second crowdsourcing tasks; and
recommend said first crowdsourcing task to a set of crowdworkers from said one or more crowdworkers based on performance of said set of crowdworkers on said set of second crowdsourcing tasks.
